(19) United States
(12) Patent Application Publication
(10) Pub. No.: US 2015/0370764 A1
(43) Pub. Date: Dec. 24, 2015

(54) USER INPUT RELATING TO MOVING DATA

(71) Applicant: International Business Machines Corporation, Armonk, NY (US)

(72) Inventors: Zhen Zhong Huo, Beijing (CN); Jia Zou, Beijing (CN)

(21) Appl. No.: 14/709,649

(22) Filed: May 12, 2015

(30) Foreign Application Priority Data
Jun. 19, 2014 (CN) 201410277170.4

(51) Int. Cl. G06F 17/22; G06F 17/30; H04L 29/08

(52) U.S. Cl. CPC G06F 17/2264; H04L 67/10; G06F 17/30076; G06F 17/30589

(57) ABSTRACT

A request is received for moving data to an application. The data at least including first data of a first data type and second data of a second data type, the first data type being different from the second data type. In response to the application not having a data processing channel supporting both the first data type and the second data type, determining whether the application has a first data processing channel supporting the first data type and a second data processing channel supporting the second data type. In response to determining that the application has the first data processing channel, processing the first data using the first data processing channel. In response to determining that the application has the second data processing channel, processing the second data using the second data processing channel.

### BACKGROUND

Users frequently need to move data to an application running on computer (see definition, below). For example, a common scenario is transferring data between different applications or within a same application. This will herein be referred to as “user-initiated-movement” (see definition, below) of “user-manipulable-data” (or sometimes, more simply as “movement of data”). Therefore, an operating system (OS) of most computer systems provide a data movement function. A common data movement function is the “copy-paste” function, wherein a copy operation allows copying designated user-manipulable-data from one application (called “a source application”) to a buffer area (called “a clipboard application”) provided by the operating system. Afterwards, by virtue of the “paste” operation, these data are transferred into another application (called “target application”). For purposes of this document, “application” will be defined as any computer program, or portion of a computer program that allows a user to manipulate (to at least some degree) user-manipulable-data.

### SUMMARY

According to an aspect of the present invention, there are methods, computer program products and systems for user-input relating to moving data. In one aspect of the invention, a request is received for moving data to an application. The data at least including first data of a first data type and second data of a second data type, the first data type being different from the second data type. In response to the application not having a data processing channel supporting both the first data type and the second data type, determining whether the application has a first data processing channel supporting the first data type and a second data processing channel supporting the second data type. In response to determining that the application has the first data processing channel, processing the first data using the first data processing channel. In response to determining that the application has the second data processing channel, processing the second data using the second data processing channel.

### BRIEF DESCRIPTION OF THE DRAWINGS

Through the more detailed description of some embodiments of the present disclosure in the accompanying drawings, the above and other objects, features and advantages of the present disclosure will become more apparent.

FIG. 1 shows an exemplary computer system/server which is applicable to implement embodiments of the present invention;

FIG. 2 shows a schematic diagram of moving data between applications;

FIG. 3 shows a schematic flow diagram of a method for moving data according to embodiments of the present invention;

FIG. 4 shows a schematic block diagram of a data package for data to be moved according to embodiments of the present invention;

FIG. 5 shows a schematic diagram of data to be moved;

FIG. 6 shows a schematic block diagram of a data package including a composite data type according to embodiments of the present invention;

FIG. 7 shows a schematic diagram of processing mixed data using different data processing channels in an application according to embodiments of the present invention; and

FIG. 8 shows a schematic block diagram of a system for moving data according to embodiments of the present invention.

In respective figures, same or like reference numerals are used to represent the same or like components.

### DETAILED DESCRIPTION

Some embodiments of the present invention avoid the use of conventional solutions for user-initiated-movement (see definition, below) of user-manipulable-data (see definition, below) that cannot process movement of “mixed user-manipulable-data” (sometimes herein referred to, more simply, as “mixed data”) well. The term “mixed data” used here refers to a portion of user-manipulable-data including data of at least two different data types. For example, it is possible that data to be moved include data of two different data types (image and text). In some embodiments of the present disclosure, if the target application cannot support both of the two data types, the corresponding data is not lost upon paste.

In some embodiments of the present disclosure, a target application supports multiple data types in mixed user-manipulable-data to be moved, and data loss does not occur. For example, a target application might process data of different data types using different data processing channels. The term “data processing channel” used here refers to software, hardware or a combination thereof for processing data of a given data type. As an example, in a target application, the data processing channels for text and image are likely independent from each other, and have their own user interface (UI) components. In some embodiments of the present disclosure, if the user performs a paste operation in a UI component (for example, a text editor) associated with the text processing channel, all data types, including but not limited to textual data, are copied into the target application. In these embodiments of the present invention, the target application supports images, and images included in the user-manipulable-data will not be lost despite the fact that the image type data is mixed with text data.

Some embodiments of the present disclosure may provide a more effective technical solution enabling user-initiated-movement of mixed user-manipulable data.

Generally, some embodiments of the present invention may provide a technical solution for moving mixed data.

According to one embodiment, a method for moving data includes the following operations (not necessarily in the following order): (i) receiving a request for moving data to an application, the data at least including first data of a first data type and second data of a second data type, the first data type being different from the second data type; (ii) in response to the application not having a data processing channel supporting both the first data type and the second data type, determining whether the application has a first data processing channel supporting the first data type and a second data processing channel supporting the second data type; (iii) in response to determining that the application has the first data processing channel, processing the first data using the first data processing channel; and (iv) in response to determining that the application has the second data processing channel, processing the second data using the second data processing channel.

According to one embodiment, a system for moving data includes: (i) a request receiving unit configured to receive a request for moving data to an application, the data at least including first data of a first data type and second data of a second data type, the first data type being different from the second data type; (ii) a determining unit configured to, in response to the application not having a data processing channel supporting both the first data type and the second data type, determine whether the application has a first data processing channel supporting the first data type and a second data processing channel supporting the second data type; (iii) a first data processing unit configured to, in response to determining that the application has the first data processing channel, process the first data using the first data processing channel; and (iv) a second data processing unit configured to, in response to determining that the application has the second data processing channel, process the second data using the second data processing channel.

It would be appreciated through the description, set forth in this document, some embodiments according to the present invention may provide a way to conveniently move hybrid data. In the case that the target application cannot directly support the format of mixed data, granularity of data movement will be lowered to respective data types in hybrid data. Specifically, for each data type in mixed data, it may be determined in the target application whether there is a data processing channel supporting the data type one by one. In this way, data loss during the data movement process can be avoided. Moreover, in some embodiments, processing of different data types may be performed progressively according to a hierarchical structure, which ensures efficient performance of data movement. Further, even some data types cannot be directly supported, some embodiments enable data type conversion to further reduce the risk of data loss.

Some preferable embodiments will be described in more detail with reference to the accompanying drawings, in which some embodiment(s) of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

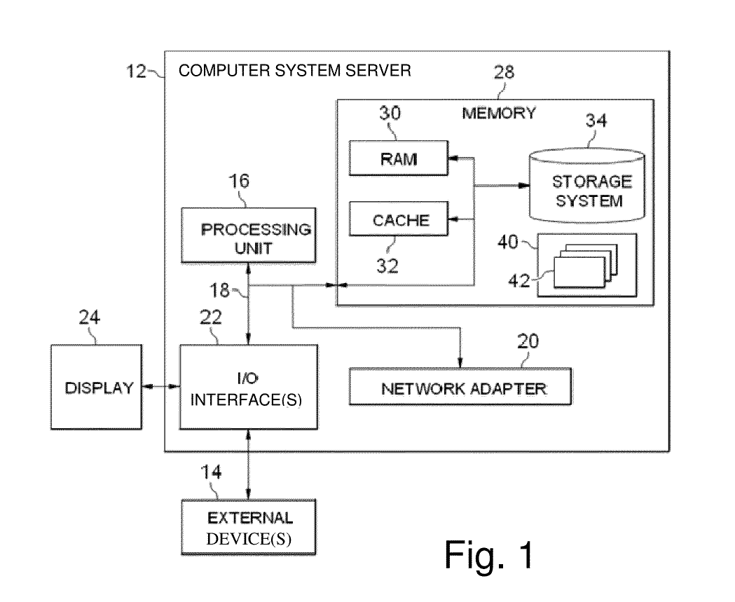

Referring now to FIG. 1, in which an exemplary computer system/server 12 which is applicable to implement embodiments of the present invention is shown. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (for example, a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (for example, at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (for example, network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (for example, the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

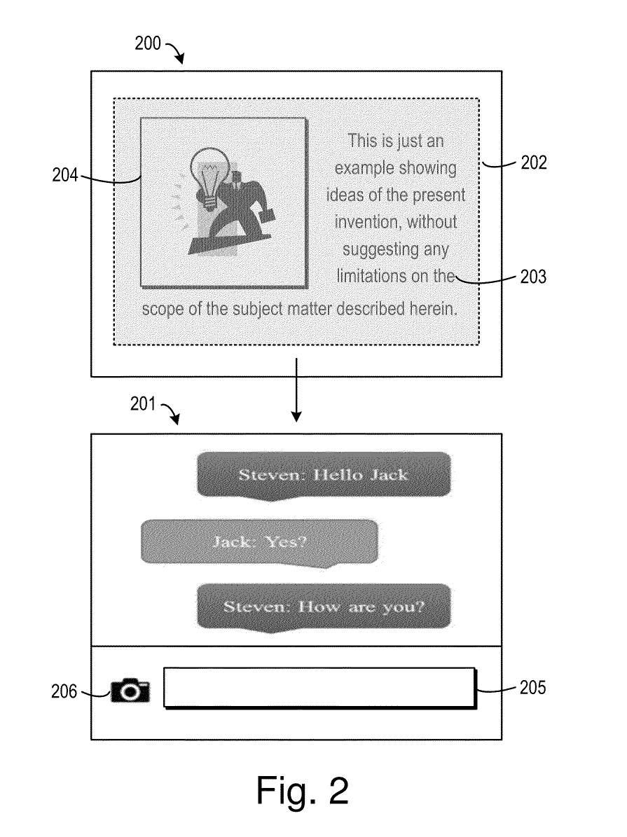

Embodiments of the present invention will now be described in detail. In the example as shown in FIG. 2, a user instructs to move data 202 from a source application 200 to a target application 201. In this example, the data to be moved 202 comprises a text 203 and an image 204. If the target application 201 supports both these two data types (image and text), then the data 202 may be directly moved in the target application 201, which is known and therefore will not be detailed here. However, if the target application does not support text or image, then the text 203 or the image 204 will be lost during the data movement process.

Moreover, due to differences in background processing, storage locations and the like, the target application 201 may receive and processing different types of data items by virtue of different data processing channels. Different data processing channels may be associated with their respective UI components. In the example shown in FIG. 2, the target application 201, which is a chat application, has a text box 205 for processing text messages and an icon 206 for adding images. The UI components 205 and 206 are associated with the text processing channel and the image processing channel of the target application 201, respectively, and these channels are independent from each other. In this case, if the user performs a “paste” operation when a focus (for example, cursor) is placed in the text box, the traditional data movement solution will lose the image 204 in the data 202, because the text box 205 cannot support processing of an image. Therefore, in the traditional data movement solution, the user at least needs two rounds of “copy-paste” operations to move the text 203 and the image 204 from the source application 200 to the target application 201, which will dampen the operation efficiency and diminish the quality of the user's experience.

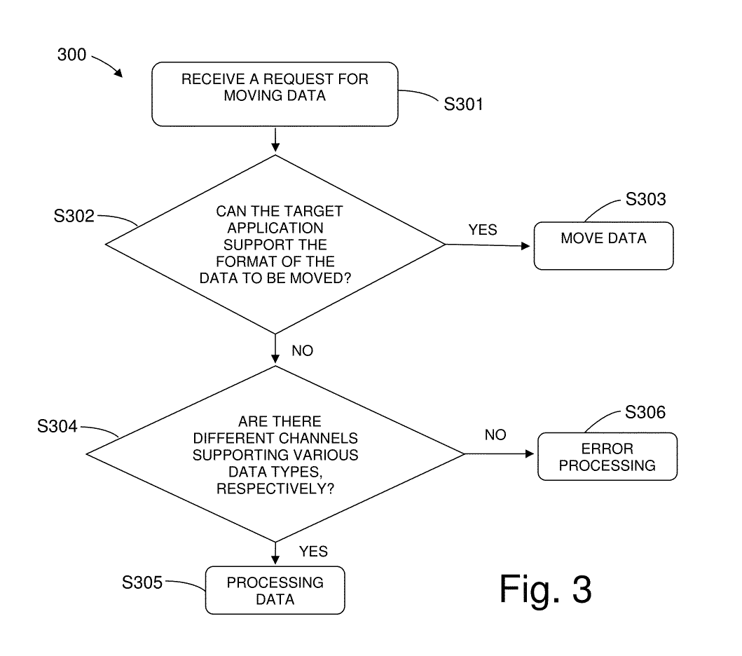

Some embodiments of the present invention provide a new solution for moving mixed data. FIG. 3 shows a flow diagram of a method 300 for moving data according to exemplary embodiments of the present invention. Method 300 is controlled by machine logic (for example, software). This machine logic may be: (i) built into the program code of a target application; (ii) built into program code of an application other than the target application; (iii) be performed by a component or module of an operating system or the like; and/or (iv) a combination of one, or more, of the foregoing forms.

At step S301, a request for moving data (that is, requesting a user-initiated movement of user-manipulable data) to an application is received. It would be appreciated that the “application” here refers to a target application as a data movement destination. According to embodiments of the present invention, a data movement request may be initiated in various manners. For example, in some applications, a user may place a focus on a target application or its particular UI component, and a data movement request may be initiated through operating interactive controls (for example, clicking onto the “paste” button) on the target application. The user may also initiate a data movement request through a predefined shortcut key, gesture, or any other appropriate interactive manners associated with the data movement function. Alternatively, in some embodiments, the system may provide a list of potential target applications to the user. The user may select one or more applications in a list, thereby initiating a data movement request.

The data to be moved may come from another application (that is, source application). Like the example described above with reference to FIG. 2, in some embodiments, the user may select data desired to move in a source application and copy the data to an application-accessible buffer area in the system (for example, a clipboard or a data bus) through operations such as “copy” or “clip”). Then, these data may be moved to a designated target application from the clipboard or data bus. Alternatively, the data to be moved may also come from any other appreciate source. The scope of the present invention is not limited in this aspect.

In particular, according to embodiments of the present invention, the data to be moved are mixed data. Specifically, such kind of data at least comprises two different types of data. The data types may be pure text, hypertext markup language (HTML) text, image, video, audio, hyperlink, and any other currently known or future developed data types. In the description infra, the data to be moved will be described as including first data of a first data type and second data of a second data type. It should be understood that it is only for the purpose of facilitating discussion, not intended to limit the scope of the present invention. The number of data types in the data to be moved may be random.

According to embodiments of the present invention, the data to be moved may be organized into a data package of a particular format. Respective data items in the data package correspond to data of respective data types. Moreover, in some embodiments, the data package may also comprise metadata, for describing information such as location, layout of the data, etc. According to embodiments of the present invention, the data package for the data to be moved may be generated by the source application in response to the user's copy action. Alternatively, such data package may also be generated by a clipboard or other dedicated component of the system.

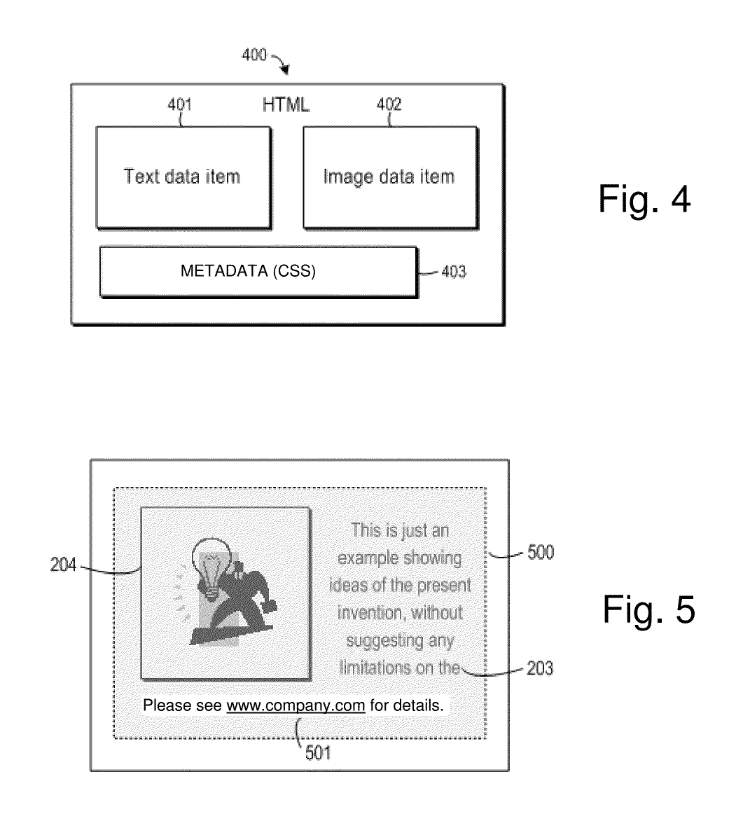

As an example, FIG. 4 shows a data package 400 for the data to be moved 202 shown in FIG. 2 according to one embodiment of the present invention. In this example, the data packet 400 is an HTML format. The data package 400 comprises a text data item 401 for the text 203 and an image data item 402 for the image 204. In some embodiments, the data item 401 and/or 402 may include the data itself. Alternatively, the data item 401 and/or 402 may only contain reference (for example, data pointer) for relevant data, and the data are stored in the buffer area of the system. As shown in the figure, the data package 400 further comprises metadata 403. In this example, the metadata 403 is a cascading style sheet, for describing the locations, layouts and the like between the text 203 and the image 204.

In some embodiments, various data in the data to be moved may be organized into a hierarchical structure according to the inclusion relationships and/or data types on the layout. For example, in one embodiment, data without an inclusion relationship (regardless of whether they have identical data types) may be arranged in the same level of the hierarchical structure. Otherwise, data with an inclusion relationship are arranged into different levels based on their inclusion relationship. For example, in the above example described with reference to, text 203 and image 204 do not include each other; therefore, they may be arranged in the same level.

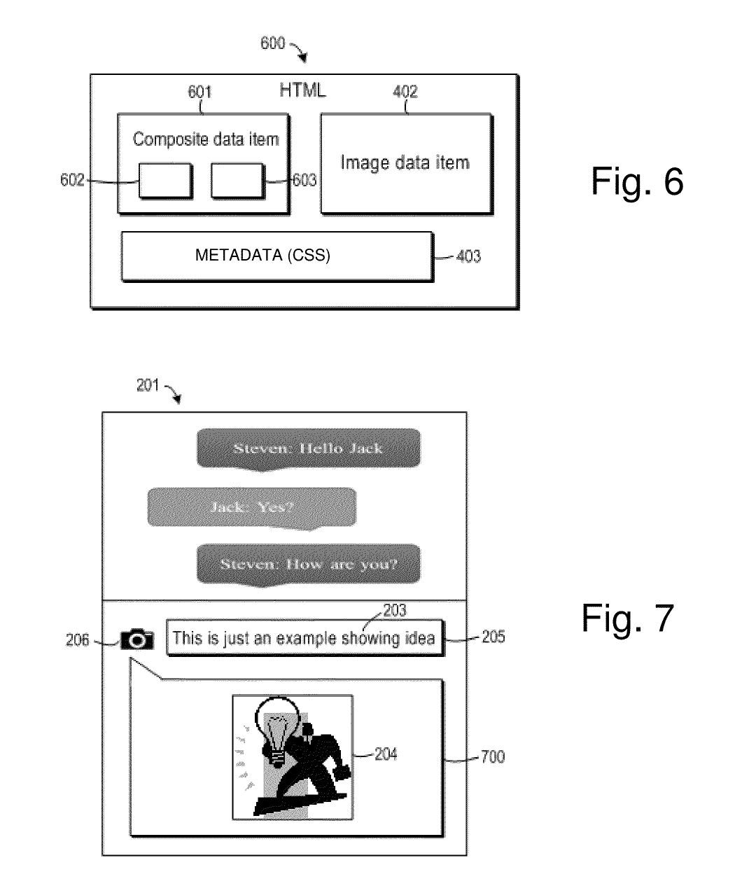

In particular, in some embodiments, the data to be moved may comprise data of a composite data type. The term “composite data type” used here is a data type composed of more than one single data type. FIGS. 5 and 6 show an example of the composite data type. The example as shown in FIG. 5 is substantially similar to FIG. 2. Except that the data to be moved 500 not only includes the pure text 203 and the image 204, but also includes a hyperlink 501. The hyperlink 501 is included in the text 203. Accordingly, in one embodiment, the two data types, pure text and hyperlink form a composite data type. FIG. 6 shows a data package 600 for the data 500. In the data package 600, the composite data item 601 corresponds to the composite data type formed by the pure text and the hyperlink and includes a data item 602 for the pure text 203 and the data item 603 for the hyperlink 501.

It is advantageous to organize the data to be moved into a hierarchical structure, which will be described in detail infra. However, it should be understood, embodiments of the present invention are not necessarily so. For example, in some alternative embodiments, the data package may be of a plane structure, wherein no hierarchical relationship exists between respective data items therein. The scope of the present invention is not limited in this aspect.

Still with reference to FIG. 3, in response to the request received at step S301 for moving data, the method 300 proceeds to step S302, where it is determined whether the target application supports the format of the received data. Specifically, suppose the data to be moved at least include first data of a first data type and second data of a second data type. At step S302, it is determined whether the target application has a data processing channel supporting both the first data type and the second data type. The term “support” used here means the target application (more specifically, the data processing channel of the target application) can parse and process data of a particular data type.

If the target application can directly process the whole data package (branch “yes”) of the data to be moved, the method 300 proceeds to step S303, where the target application directly receives and processes data. For example, in the example described above with reference to FIG. 4, if a data processing channel resolves and processes the data package 400 of the HTML format, then the target application may directly receive the data to be moved, and process the data items in the data package 400. In particular, even if the target application 201 cannot directly support the data package 400, the target application 201 can be considered to be capable of supporting the format of the data to be moved if it can convert the whole data package 400 into a supported format (for example, image).

On the other hand, if it is determined at step S302 that the target application does not have a data processing channel that supports both the first data type and the second data type (branch “No”), the method 300 proceeds to step S304, where it is determined whether the target application have different data processing channels supporting the data types, respectively. That is, it is determined whether the target application has a first data processing channel supporting the first data type and a second data processing channel for supporting the second data type. It would be appreciated that in this case, embodiments of the present invention would determine whether the target application has corresponding data processing channels for different data types in the data to be moved. For example, in one embodiment, for each data type in the data to be moved, it is determined whether the target application has a data processing channel capable of supporting the data type, one by one.

For example, in the example shown in FIG. 4, suppose the target application 201 cannot support a data package 400 of an HTML format. At this point, at step S304, it will be determined whether the target application has a data processing channel supporting text and a data processing channel supporting image. In this way, it may be effectively avoided that data items of a particular type in the data to be moved are discarded.

Return to FIG. 2 to consider a specific example. Suppose the user performs a “paste” operation in the case that the focus is in the text box 205 of the target application 201. In this case, it is determined at step S302 that the target application 201 does not have a data processing channel supporting both the text and image data types. Moreover, a text processing channel associated with the text box 205 cannot support image. Therefore, at step S304, it is determined, separately, whether the target application 200 has a first data processing channel supporting text (first data type) and a data processing channel supporting image (second data type). In this example, it is determined that the target application 200 has the first data processing channel supporting text, namely, a text processing channel associated with the text box 205; and the second data processing channel supporting image, namely, the image processing channel associated with the image icon 206. Correspondingly, the text 203 and the image 204 may be processed by the first and second data processing channels, respectively.

It can be seen from this example that when the request for moving data is initiated at a first UI component associated with the first data processing channel, even if the first data processing channel does not support the second data type in the data to be moved, data loss will not occur. The reason is that according to embodiments of the present invention, a second data processing channel supporting the second data type will be searched in the target application.

In particular, in an embodiment where the data to be moved is organized in a hierarchical structure, respective data types may be processed in an order specified by the hierarchical structure. In one embodiment, the processing may be performed in an order from top to bottom. Alternatively, any other order that can traverse the hierarchical structure is feasible. By virtue of such progressive or tentative manner, efficiency of data movement can be further enhanced. Consider the example shown in FIG. 6, suppose the target application cannot support an HTML data package 600 including a composite data item 601 and an image data item 402. The target application will process data of respective data types level by level according to the hierarchical structure. If the text processing channel of the target application 201 can process a composite data item 601 composed of a pure text data item 602 and a hyperlink data item 603. At this point, the text processing channel of the target application 201 may directly process the composite data item 601, without separately processing data items 602 and 603. In this manner, the capacity of the data processing channel can be utilized to the utmost extent to avoid unnecessary processing operations.

In particular, at step S304, the process of determining a data processing channel may comprise determining whether one or more data types in the data to be moved can be converted into a target format directly supported by at least one data processing channel in the target application. For example, still consider the example in FIG. 2, where data to be moved 202 include text 203 and image 204. Suppose the target application 201 is an image reader and only has an image processing channel. The target application 201 does not have a data processing channel that can directly support text. However, if the target application 201 can convert the text 203 into image, the text 203 may also be rendered and processed by virtue of the image processing channel, without bothering to discard the text data. In this manner, the risk of data loss can be further reduced.

Furthermore, in some embodiments, determining a data processing channel at step S304 may be performed autonomously by respective data processing channels of the target application. In such an embodiment, for each data processing channel, the data type(s) supported thereby is accessible. For example, information of the data type(s) supported by one data processing channel may be pre-encoded into the data processing channel, or stored at a storage location accessible to the data processing channel. When receiving the request for moving data, one or more data processing channels of the target application are triggered. Each triggered data processing channel may automatically detect whether the received data have a data type supported by the data process channel. In the case of yes, the data processing channel may retrieve data items of the corresponding data type and perform processing.

In particular, as known, the data processing channel may be associated with a particular UI component on an interface of the application. For example, the text processing channel may detect data to be moved by virtue of an associated UI component. Specifically, in such an embodiment, the UI component may be triggered in response to the request for moving data, so as to determine whether the associated data processing channel supports one or more data types in the data to be moved.

It is advantageous to detect a data type based on a data processing channel. In such an embodiment, when constructing an application, it is unnecessary to specifically design and develop a corresponding function for supporting movement of mixed data. On the contrary, a solution for moving mixed data according to embodiments of the present invention can be easily supported only by simply reusing a data processing channel and/or a mixed data movement function of an associated UI component. In this way, the development cost and cycle of an application will be reduced. Of course, it should be noted that the scope of the present invention is not limited thereto. In some alternative embodiments, detection of a data type may be performed by an application, and the data may be allocated to a data processing channel supporting a corresponding data type.

Continue referring to FIG. 3. If it is determined at step S304 that the target application has different data processing channels supporting various data types, then at step S305, these data processing channels may be used to process data items of the corresponding data types. More specifically, in response to determining at step S304 that the target application has a first data processing channel supporting a first data type, the first data are processed using the first data processing channel at step S305; in response to determining at step S304 that the target application has a second data processing channel supporting a second data type, the second data are processed using the second data processing channel at step S305; and so on and so forth. In one embodiment, for example, the data processing channel may render the data item to the user by virtue of an associated UI component.

Moreover, in some embodiments, processing data using the data processing channel may include converting data into a data type directly supported by the data processing channel. For example, the first data may be converted from the first data type into a type directly supported by the first data processing channel. Similarly, the second data is converted from the second data type into a type directly supported by the second data processing channel; and so on and so forth.

For example, according to embodiments of the present invention, in the example shown in FIG. 2, the target application 201 may process text 203 using the text box 205 associated with the text processing channel and process image 204 using an icon 206 associated with the image processing channel. Specifically, as shown in FIG. 7, in response to receiving a request for moving data 202 at the target application 201, the text 203 will be displayed in the text box 205. Moreover, a trigger event for the icon 206 may be generated in the target application 201, such that the target application 201 presents the UI area 700 for adding an image. Correspondingly, the image 204 may be displayed in the UI area 700 and may be sent in a chat session.

On the other hand, for a certain specific data type in the data to be moved, if it is determined at step S304 that the target application does not have a data processing channel supporting the data type, error processing is performed at step S306. In one embodiment, error processing may include discharging data of a data type that the target application cannot process. Alternatively, at step S306, a prompt of discarding data may be provided to the user. It should be understood that different from the prior art, no data in the data to be moved are directly discarded. Instead, the corresponding data will not be discarded until it is determined that the target application surely cannot support the data type.

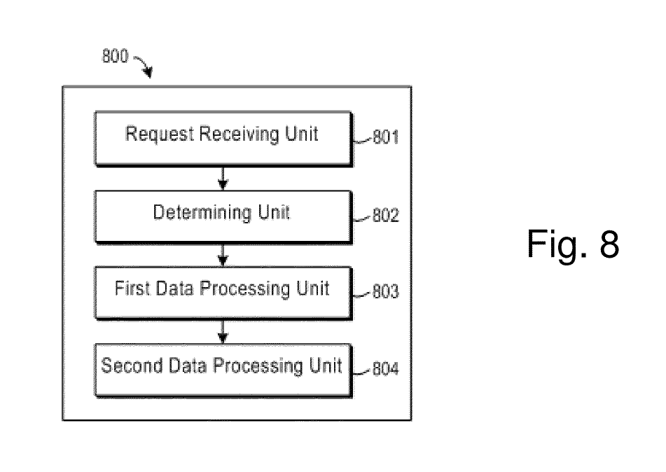

FIG. 8 shows a block diagram of a system 800 for moving data according to one embodiment of the present invention. As shown in the figure, the system 800 comprises: a request receiving unit 801 configured to receive a request for moving data to an application, the data at least including first data of a first data type and second data of a second data type, the first data type being different from the second data type; a determining unit 802 configured to, in response to the application not having a data processing channel supporting both the first data type and the second data type, determine whether the application has a first data processing channel supporting the first data type and a second data processing channel supporting the second data type; a first data processing unit 803 configured to, in response to determining that the application has the first data processing channel, process the first data using the first data processing channel; and a second data processing unit 804 configured to, in response to determining that the application has the second data processing channel, process the second data using the second data processing channel.

In some embodiments, the first data and the second data are arranged in a hierarchical structure. In such an embodiment, the determining unit 802 comprises a progressive determining unit configured to determine whether the application has the first data processing channel and the second data processing channel according to an order specified by the hierarchical structure. In some embodiments, at least one of the first data type and the second data type is a composite data type composed of a plurality of simple data types.

In some embodiments, the determining unit 802 comprises: a channel-based determining unit configured to cause at least one data processing channel of the application to automatically detect the data, so as to determine whether the at least one data processing channel supports at least one of the first data type and the second data type.

In some embodiments, the first data processing unit 803 comprises: a converting unit configured to convert the first data from the first data type into a data type directly supported by the first data processing channel. Alternatively or additionally, the second data processing unit 804 may also have a similar converting unit.

In some embodiments, the first data processing unit 803 comprises: an interactive processing unit configured to process the first data using a user interface component associated with the first data processing channel. Alternatively or additionally, the second data processing unit 804 may also have a similar interactive processing unit.

It should be noted that for the sake of clarity, FIG. 8 does not show optional units or sub-units included in the system 800. All features and operations as described above are suitable for system 800, respectively, which are therefore not detailed here. Moreover, partitioning of units or subunits in system 800 is exemplary, rather than limitative, intended to describe its main functions or operations logically. A function of one unit may be implemented by a plurality of other units; on the contrary, a plurality of units may be implemented by one unit. The scope of the present invention is not limited in this aspect.

Moreover, the units included in the system 800 may be implemented by various manners, including software, hardware, firmware or a random combination thereof. For example, in some embodiments, the system 800 may be implemented by software and/or firmware. Alternatively or additionally, the system 800 may be implemented partially or completely based on hardware. For example, one or more units in the system 800 may be implemented as an integrated circuit (IC) chip, an application-specific integrated circuit (ASIC), a system on chip (SOC), a field programmable gate array (FPGA), etc. The scope of the present intention is not limited to this aspect.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

For example the following paragraphs set forth some definitions for certain words or terms for purposes of understanding and/or interpreting this document.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

User-initiated-movement: pasting any user-manipulable-data into any target application in response to any form of user input effectively requesting the user-initiated-movement; “user-initiated-movements” include, but are not necessarily limited to: (i) data pasted into a target application as part of a copy operation; (ii) data pasted into a target application as part of a cut-and-copy operation; and/or (iii) a predetermined data portion that can be pasted into a target application (for example, some conventional word processors include “auto-text” or “quick parts” that can be pasted into word processing documents; “user-initiated-movement” includes embodiments where the data is transformed (for example, text automatically translated into a different natural language, video that is automatically put in a predetermined compressed format when it is pasted) as it is pasted.

User-manipulable-data: any data that can be pasted into a target application in response to user input effective requesting a “user-initiated-movement.”

What is claimed is:

1. A method of moving data, comprising:
receiving user input in the form of a request for performing a user-initiated move of user-manipulable-data into or within an application, the user-manipulable-data at least including first data of a first data type and second data of a second data type, the first data type being different from the second data type;
determining that the application does not include a data processing channel supporting both the first data type and the second data type;
in response to the determination that the application does not include a data processing channel supporting both the first data type and the second data type, determining whether the application has a first data processing channel supporting the first data type;
in response to determining that the application has the first data processing channel, performing the user-initiated-move of the first data within or into the application using the first data processing channel of the application;
in response to the determination that the application does not include a data processing channel supporting both the first data type and the second data type, determining whether the application has a second data processing channel supporting the second data type; and
in response to determining that the application has the second data processing channel, performing the user-initiated-move of the second data within or into the application using the second data processing channel of the application.

2. The method according to claim 1, further comprising:
arranging a plurality of data types, including the first and second data types, into a hierarchical data structure; and
determining, based at least in part upon respective positions of the first data type and the second data type in the hierarchical data structure, a relative time-ordering of the following two operations:
the determination of whether the application has a first data processing channel supporting the first data type, and
the determination of whether the application has a second data processing channel supporting the second data type.

3. The method according to claim 2, wherein at least one of the first data type and the second data type is a composite data type, the composite data type including a plurality of simple data types.

4. The method according to claim 1, further comprising:
detecting the user-manipulable-data by at least one data processing channel of the application to determine whether the at least one data processing channel supports at least one of the first data type and the second data type.

5. The method according to claim 1, wherein the performance of the user-initiated-move of the first data using the first data processing channel comprises:
converting the first data from the first data type into a data type that is directly supported by the first data processing channel.

6. The method according to claim 1, wherein the performance of the user-initiated move of the first data using the first data processing channel comprises:
using a first user interface component associated with the first data processing channel.

7. A computer program product for moving data, the computer program product comprising a computer readable storage medium having program instructions embodied therewith, the program instructions executable by a processor to:
receive user input in the form of a request for performing a user-initiated move of user-manipulable-data into or within an application, the user-manipulable-data at least including first data of a first data type and second data of a second data type, the first data type being different from the second data type;
determine that the application does not include a data processing channel supporting both the first data type and the second data type;
in response to the determination that the application does not include a data processing channel supporting both the first data type and the second data type, determine whether the application has a first data processing channel supporting the first data type;
in response to determining that the application has the first data processing channel, perform the user-initiated-move of the first data within or into the application using the first data processing channel of the application;
in response to the determination that the application does not include a data processing channel supporting both the first data type and the second data type, determine, by machine logic, whether the application has a second data processing channel supporting the second data type; and
in response to determining that the application has the second data processing channel, perform the user-initiated-move of the second data within or into the application using the second data processing channel of the application.

8. The computer program product according to claim 7, wherein the program instructions are further executable by a processor to:
arrange a plurality of data types, including the first and second data types, into a hierarchical data structure; and
determine, by machine logic and based at least in part upon respective positions of the first data type and the second data type in the hierarchical data structure, a relative time-ordering of the following two operations:
the determination of whether the application has a first data processing channel supporting the first data type, and
the determination of whether the application has a second data processing channel supporting the second data type.

9. The product according to claim 8, wherein at least one of the first data type and the second data type is a composite data type, the composite data type including a plurality of simple data types.

10. The product according to claim 7, wherein the medium has further stored thereon:
seventh program instructions programmed to detect the user-manipulable-data by at least one data processing channel of the application to determine whether the at least one data processing channel supports at least one of the first data type and the second data type.

11. The product according to claim 7, wherein the fourth program instructions are further programmed to perform the user-initiated-move of the first data using the first data processing channel comprising:
converting the first data from the first data type into a data type that is directly supported by the first data processing channel.

12. The product according to claim 7, wherein the fourth program instructions are further programmed to perform the user-initiated-move of the first data using the first data processing channel comprising:
using a first user interface component associated with the first data processing channel.

13. A system for moving data, comprising:
a computer readable storage medium having program instructions embodied therewith;
a processor, wherein the program instructions are executable by the processor to:
receive user input in the form of a request for performing a user-initiated move of user-manipulable-data into or within an application, the user-manipulable-data at least including first data of a first data type and second data of a second data type, the first data type being different from the second data type,
determine, by machine logic, that the application does not include a data processing channel supporting both the first data type and the second data type,
in response to the determination that the application does not include a data processing channel supporting both the first data type and the second data type, determine, by machine logic, whether the application has a first data processing channel supporting the first data type,
in response to determining that the application has the first data processing channel, perform the user-initiated-move of the first data within or into the application using the first data processing channel of the application,
in response to the determination that the application does not include a data processing channel supporting both the first data type and the second data type, determine, by machine logic, whether the application has a second data processing channel supporting the second data type, and
in response to determining that the application has the second data processing channel, perform the user-initiated-move of the second data within or into the application using the second data processing channel of the application.

14. The system according to claim 13, wherein the processor:
seventh program instructions programmed to arrange a plurality of data types, including the first and second data types, into a hierarchical data structure; and
eighth program instructions programmed to determine, by machine logic and based at least in part upon respective positions of the first data type and the second data type in the hierarchical data structure, a relative time-ordering of the following two operations:
the determination of whether the application has a first data processing channel supporting the first data type, and
the determination of whether the application has a second data processing channel supporting the second data type.

15. The system according to claim 14, wherein at least one of the first data type and the second data type is a composite data type, the composite data type including a plurality of simple data types.

16. The system according to claim 13, wherein the medium has further stored thereon:
seventh program instructions programmed to detect the user-manipulable-data by at least one data processing channel of the application to determine whether the at least one data processing channel supports at least one of the first data type and the second data type.

17. The system according to claim 13, wherein the fourth program instructions are further programmed to perform the user-initiated-move of the first data using the first data processing channel comprising:
converting the first data from the first data type into a data type that is directly supported by the first data processing channel.

18. The system according to claim 13, wherein the fourth program instructions are further programmed to perform the user-initiated-move of the first data using the first data processing channel comprising:
using a first user interface component associated with the first data processing channel.
